(19) United States
(12) Patent Application Publication
(10) Pub. No.: US 2014/0081715 A1
(43) Pub. Date: Mar. 20, 2014

(54) SYSTEMS AND METHODS OF COACHING USERS IN AN ON-DEMAND SYSTEM

(71) Applicant: salesforce.com, inc., San Francisco, CA (US)

(72) Inventors: Ashwini Govindaraman, Hayward, CA (US); Daniel Debow, San Francisco, CA (US); David Stein, San Francisco, CA (US); Jager McConnell, San Francisco, CA (US); Ciara Peter, San Francisco, CA (US)

(73) Assignee: salesforce.com, inc., San Francisco, CA (US)

(21) Appl. No.: 14/032,171

(22) Filed: Sep. 19, 2013

Related U.S. Application Data
(60) Provisional application No. 61/703,164, filed on Sep. 19, 2012.
(60) Provisional application No. 61/813,065, filed on Apr. 17, 2013.

(51) Int. Cl. G06Q 10/06; G06Q 50/20

(52) U.S. Cl. CPC G06Q 10/06398; G06Q 50/2057
USPC 705/7.42

(57) ABSTRACT

The technology disclosed relates to tracking performance and initiatives of employees and automatically and proactively providing personalized coaching based on each employee's performance. In particular, it relates to automatically issuing personalized performance enhancement insights to an employee by evaluating the employee's current performance against progress features and exception features through timely performance checks. The progress features indicate a progression of an individual across a work cycle and exception features indicate low or high performance of the individual during the work cycle. Thus the personalized performance enhancement insights are automatically awarded when the current performance of the employee evidences lags in progress, regression, or low or high performance.

### RELATED APPLICATION

This application claims the benefit of two US provisional patent applications, including: No. 61/703,164, entitled, “Systems and Methods for Interacting with Employees,” filed 19 Sep. 2012 (Attorney Docket No. SALE 1038-1/1039PROV); and No. 61/813,065, entitled, “System and Method for Automated Triggering of One-to-One Coaching Notes,” filed 17 Apr. 2013 (Attorney Docket No. SALE 1059-1/1169PROV). The provisional applications are hereby incorporated by reference for all purposes.

This application is related to US patent application entitled “Systems and Methods of Rewarding Users in an On-Demand System,” (Attorney Docket No. SALE 1038-4/1039PROV) filed contemporaneously. The related application is incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Social media platforms have transformed the way users connect and share information. Yet the systems most organizations use to manage work are designed for the hierarchical, siloed, slow-moving workplace. Such systems automate needless bureaucracy and painful reviews instead of improving productivity and results. And they often feel like work on top of work.

An opportunity arises to automatically provide employees with personalized coaching by comparing their current performance to work goals and performance of their relevant colleagues. Improved employee experience and engagement, improved sales and revenues, and higher employee satisfaction and retention may result.

### SUMMARY

The technology disclosed relates to tracking performance and initiatives of employees and automatically and proactively providing personalized coaching based on each employee's performance. In particular, it relates to automatically issuing personalized performance enhancement insights to an employee by evaluating the employee's current performance against progress features and exception features through timely performance checks. The progress features indicate a progression of an individual across a work cycle and exception features indicate low or high performance of the individual during the work cycle. Thus the personalized performance enhancement insights are automatically awarded when the current performance of the employee evidences lags in progress, regression, or low or high performance.

Other aspects and advantages of the present technology can be seen on review of the drawings, the detailed description and the claims, which follow.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows an example coaching environment of coaching users in an on-demand system.

FIG. 2A is one implementation of a performance schema that tracks sales initiatives juxtapose sales goals.

FIG. 2B shows one implementation of performance records that record sales initiatives against sales goals.

FIG. 3 illustrates one implementation of historical performance data generated from reports.

FIGS. 4A-4C illustrate one implementation of progress features extracted from historical performance data.

FIG. 5 shows one implementation of exception features extracted from historical performance data.

FIG. 6 illustrates one implementation of automated coaching of users in an on-demand system.

FIG. 7 is one implementation of user triggered coaching of users in an on-demand system.

FIG. 8 shows one implementation of a coaching schema that can be used for coaching users in an on-demand system.

FIG. 9 is a flowchart of one implementation of proactively coaching users in an on-demand system.

FIG. 10 illustrates a flowchart of one implementation of automatically issuing personalized coaching insights to users in an on-demand system.

FIG. 11 is a block diagram of an example computer system used for coaching users in an on-demand system.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The technology disclosed relates to coaching users in an on-demand system by using computer-implemented systems. The technology disclosed can be implemented in the context of any computer-implemented system including a database system, a multi-tenant environment, or the like. Moreover, this technology can be implemented using two or more separate and distinct computer-implemented systems that cooperate and communicate with one another. This technology may be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “specify” is used herein to mean the same as “identify.”

Examples of systems, apparatus, and methods according to the disclosed implementations are described in a “sales” context. The examples of sales performance metrics are being provided solely to add context and aid in the understanding of the disclosed implementations. In other instances, examples of performance metrics in other industries like energy and utilities, education, agriculture and mining, medical services, etc. may be used. Other applications are possible, such that the following examples should not be taken as definitive or limiting either in scope, context, or setting. It will thus be apparent to one skilled in the art that implementations may be practiced in or outside the “sales” context.

A study from the Sales Executive Council found that sales representatives who received three or more hours of coaching per month outsold those who received two hours or less of coaching per month, by as much as 17 percent. According to the Corporate Executive Board, effective sales coaching can potentially increase top-line revenue by up to 20 percent.

With the technology disclosed, organizations can create a culture of meaningful coaching at work. The technology disclosed relates to improving sales organizations by automatically providing personalized coaching to sales representatives based on each sales representative's performance metrics. It can enable organizations to produce more satisfying results by proactively identifying underperforming sales representatives and reasons for the underperformance. It can then provide personalized performance enhancement insights that are specific to the sales representatives and their issues.

The technology disclosed can be used by employees to improve job performance and reduce unnecessary learning time. It can also enable high performing employees to become more effective and successful. Using the technology disclosed, the organizations can coach their employees to replicate best performance behaviors by delivering feedback on how employees are performing against their goals.

The technology disclosed provides a social performance management platform like Salesforce's Work.com, which helps organizations guide and assist sales representatives. The technology disclosed can be used to manage in real-time, drive alignment with goals, and coach underperformers with personalized performance enhancement insights and one-to-one coaching notes. It also provides insights into progress of sales representatives by measuring the performance of sales activities and thus determining the effectiveness of the sales representatives. In some implementations, managers can view dashboards summarizing sales representatives' goal achievements, pipeline reports, milestone reports that compare sales representatives' current performance to historical performance of the organization and of the relevant colleagues. By constantly measuring sales representatives' current performance against their sale targets and goals and among other sales representatives with similar sale targets and goals, the technology disclosed can identify and coach underperforming sales representatives.

### Coaching Environment

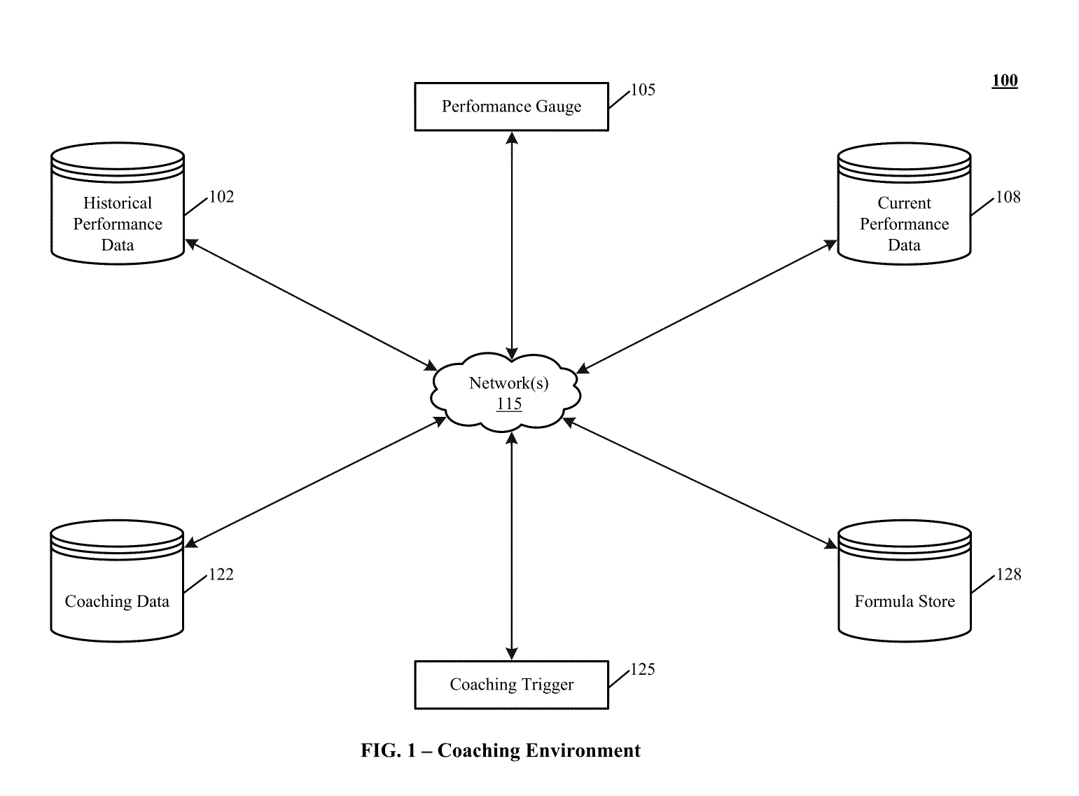

FIG. 1 shows an example coaching environment 100 of coaching users in an on-demand system. FIG. 1 includes historical performance data 102, current performance data 108, coaching data 122, and formula store 128. FIG. 1 also includes network(s) 115, performance gauge 105, and coaching trigger 125. In other implementations, environment 100 may not have the same elements as those listed above and/or may have other/different elements instead of, or in addition to, those listed above such as an assignment engine, a fund store, or an application running on a computing device. The different elements can be combined into single software modules and multiple software modules can run on the same hardware.

In some implementations, network(s) 115 can be any one or any combination of Local Area Network (LAN), Wide Area Network (WAN), WiFi, telephone network, wireless network, point-to-point network, star network, token ring network, hub network, peer-to-peer connections like Bluetooth, Near Field Communication (NFC), Z-Wave, ZigBee, or other appropriate configuration of data networks, including the Internet.

In some implementations, the engines can be of varying types including workstations, servers, computing clusters, blade servers, server farms, or any other data processing systems or computing devices. The engines can be communicably coupled to the databases via a different network connection. For example, performance gauge 105 can be coupled via the network(s) 115 (e.g., the Internet) and coaching trigger 125 can be coupled via a direct network link or a different network connection.

In some implementations, databases can store information from one or more tenants into tables of a common database image to form a multi-tenant database system (MTS). A database image can include one or more database objects. In other implementations, the databases can be relation database management systems (RDBMSs), object oriented database management systems (OODBMSs), distributed file systems (DFS), no-schema database management systems, or any other data storing systems or computing devices.

In general, a CRM system allows organizations to manage business relationships and the data and information associated with them. It allows organizations to store customer and contact information as reports. A report returns a set of records that meets certain criteria, and displays it in organized rows and columns. Report data can be filtered, grouped, sorted, and displayed graphically as a chart. A report type defines the set of records and fields available to a report based on the relationships between a primary object and its related objects. Reports display only records that meet the criteria defined in the report type. In one implementation, a tabular report can display the row of records in a table like format with grand total. In another implementation, a summary report can group and sort rows of data to display subtotals. For instance, in a recruiting application, a summary report can be used to display open positions classified by department name. In yet another implementation, a matrix report can summarize information in a grid format and group records by columns and rows.

Applied to sales and other CRM activities, summary and matrix reports, dashboards and scorecards (collectively, reports and displays) provide graphical representations of performance. In one implementation, dashboards show data from source reports as visual components, which can be charts, gauges, tables, or metrics. Dashboards can highlight specific data, trends, and deviations from the trends such as a pipeline graph by sales region, opportunities, closed revenue by quarter, order history by account, sales actual vs. quota per sales representative, opportunities per sales representative, closed deals per sales representative, etc.

The technology disclosed builds on these reports and displays by automatically determining performance criteria used by an organization. Performance criteria automatically extracted can be analyzed and auto-badging and auto-thanking criteria established. Filtering, sorting and subtotaling structures of reports and displays are particularly useful in automatically determining performance criteria. Filtering structures show a viewer a subset of organization data of personal interest. For instance, a manager filters data to focus on his work group. Filtering structures can be extracted from query criteria selectors, SQL queries, scripts, API calls and equivalent filtering structures used to select data includes in reports and displays. Sorting and subtotaling structures organize and summarize data into strata. For instance, a sales report is sorted by territory and sales representative within the territory and subtotaled by territory. This sorting and subtotaling structure reveals that sales representatives and territories are evaluated for performance. The sales representatives and territories are compared to each other. Sorting criteria can be extracted from sort criteria selectors, SQL queries, scripts, API calls and equivalent sort order specification structures used to organize data included in reports and displays. Subtotaling criteria often are specified in the same place as sorting criteria, as these reporting and display features are closely related. Automatic extraction of performance measures of interest can focus on filtering, sorting, and subtotaling in reports and displays.

In some implementations, automatically extracted performance measures are heuristically evaluated against multi-tenant experience with performance measures. Sales is not a new profession, though each sales organization can be somewhat unique. Based on programmed experience or machine learning of performance measures used by multiple tenant organizations that subscribe to a multi-tenant system, extracted performance measures can be evaluated and rules applied to select among candidate performance measures extracted by evaluation of the reports and displays that an organization uses. In one implementation, each tenant organization can add or define custom fields for inclusion in a standard object. Custom fields for multiple tenants are stored in a single field within the object data structure, and this single field can include different data types for each tenant. Indexing columns are also provided, wherein a tenant organization can designate a field for indexing. Data values for designated fields can be copied to an index column, and each index column can include multiple data types. Each tenant organization may also define custom objects including custom fields and indexing columns. Custom objects for multiple tenant organizations can be stored in a single custom object data structure.

Reports and displays can further be evaluated based on how frequently the reports and displays are accessed. A performance reporting system typically includes dozens of reports and displays that are used infrequently and a few reports that are used often. In the reports that are often used, filter, sorting, and subtotaling criteria typically are used repeatedly with minor variation, such as changing the filter dates to select the most recent month, quarter or rolling period. Automatically extracted performance measures can be weighted and prioritized by how often they are actually used by an organization or part of an organization. Report and display logs can be accessed to determine usage.

Human judgment can supplement automatic extraction and weighted usage, especially when many reports and displays are used. In some implementations, the technology disclosed presents a menu or pick list of performance measures from which a human user can select performance measures used to issue personalized performance enhancement insights. The menu or pick list can be organized thematically, alphabetically, or in another order. All or part of a menu or pick list can be organized to emphasize most frequently used performance criteria and/or to rank order measures reviewed by an organization or part of an organization in reports and displays.

Extraction of performance measures, in some implementations, can be accompanied by automatic identification of progress and exception features. Progress features can be detected by stateful progression, such as completion of training unit two following training unit one. Stateful progression is often reflected in enumerated states or attribute lists. Progress also can be reflected in unstructured lists that are counted or listed. The technology disclosed can distinguish such progress features from exception features by programmed or machine learning. Exception features apply to performance measures that are quantified, as opposed to progressive, such as total sales in a month or average size of deals in a quarter. Quantitative performance measures can be statically evaluated by parametric or non-parametric methods to find exceptional poor performance. In addition, quantitative performance measures can be evaluated to identify infrequent events such as lowest sales revenue or losing an existing account. Exceptional performance criteria can be established statistically, identifying to quartile, bottom 10 percent or underperformers for a period. Exceptional performance criteria also can be applied on a lifetime basis or to an extended evaluation period such as a year.

Summary and matrix reports can be used to generate dashboards and scorecards that are graphical representation of reports. In one implementation, dashboards show data from source reports as visual components, which can be charts, gauges, tables, or metrics. Dashboards can highlight specific data, trends, and deviations from the trends such as a pipeline graph by sales region, opportunities, closed revenue by quarter, order history by account, sales actual vs. quota per sales representative, opportunities per sales representative, closed deals per sales representative, etc.

In other implementations, scorecards can provide a high-level summary of key performance indicators (KPIs) for a given analysis area by displaying data of actual performance compared to planned targets and goals. Examples of scorecards include closed-won opportunities by month scorecard, lead activities scorecard, pipeline opportunities by close date and opportunity stage scorecard, open opportunities by created date scorecard, stage movement scorecard, opportunity conversion ratio scorecard, average closed deals size scorecard, etc.

Formula store 128 includes various filtering, sorting, and subtotaling features of the reports that can be used by performance gauge 105 to generate historical performance data 102 and current performance data 108. For instance, performance gauge 105 can calculate a “qualification rate” for a sales representative using the following formula:

Qualification Rate=[Leads/Opportunitites]*100

This rate indicates what percentage of opportunities assigned to the sales representative advanced into leads. In other implementations, qualification rates can be stratified by industry types, market segments, customer segments, employee sizes, product lines, service types, stock rates, locations, and territories

In another example, a sales representative's “closing rate” can be calculated by the performance gauge 105 using the following formula:

Closing Rate=[Accounts/Prospects]*100

The closing rate can represent what percentage of leads assigned to or advanced by the sales representative got converted into accounts. In other implementations, closing rates can be stratified by industry types, market segments, customer segments, employee sizes, product lines, service types, stock rates, locations, and territories.

In yet another example, performance gauge 105 can determine the average dollar amount brought in by each sales contract secured by a particular sales representative, which is referred to as “revenue conversion rate.” This rate can be normalized by eliminating very high and low values that skew the average. Revenue conversion rates can also be stratified by industry types, market segments, customer segments, employee sizes, product lines, service types, stock rates, locations, and territories. In one implementation, performance engine 105 can use the following formula to calculate the revenue conversion rate of a sales representative:

Revenue Conversion Rate=[Revenue/Accounts]

In other implementations, performance gauge 105 can use the formulas stored in formula store 128 to calculate various performance metrics for the sales representatives, including lead response time, rate of contact, rate of follow up contact, clicks from sales follow-up emails, social media usage, usage rate of marketing collateral, opportunity-to-win ratio, average sales per sales representative, or bottom 20% of sales representatives.

Historical performance data 102 includes sales goals, milestones, or targets specified for various sales cycles. In some implementations, it can include model values for performance metrics such as leading and lagging indicators that can be used for comparative analysis against current performance of the sales representatives. In one example, leading indicators can identify model values for stage progression or regression percentages, which identify what percentages of the opportunities may or may not qualify to the next stage or phase in a sales cycle. In another example, lagging indicators can identify model values for the average number of days an opportunity should be in a given stage or phase in a sales cycle.

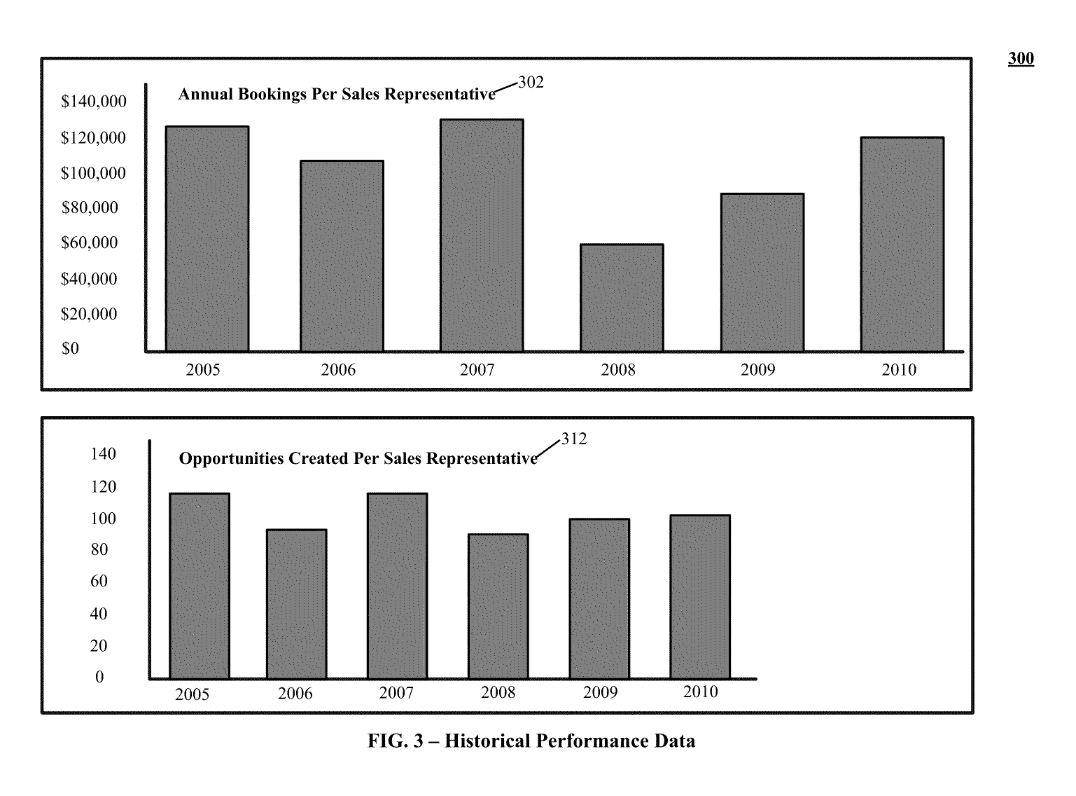

In other implementations, historical performance data 102 includes data collected over time from pervious sales cycles. For instance, FIG. 3 illustrates one implementation of historical performance data 102 generated from reports. In particular, FIG. 3 shows average annual bookings 302 made by the sales representatives from the years 2005 to 2010. FIG. 3 also shows an average number of opportunities 312 created by sales representatives from the years 2005 to 2010. In other implementations, historical performance data 102 can include pipeline trend ratio, average share ratio, sales trend ratio, etc.

Current performance data 108 provides detailed performance summaries for sales representatives on quarter-by-quarter basis, including performance metrics such as conversion compared to opportunities size, opportunity conversion rate, and quota achievement. In one implementation, performance gauge 105 can analyze performance of sales representatives against goals set at the beginning of a quarter, sales activities by region and quarter, revenue distribution by sales region, revenue and closure trend by sales industry, quota performance by sales district, etc.

In one example, performance gauge 105 can define a “sales representative-target” table, which includes names of the sales representatives along with their yearly, quarterly, monthly, or weekly goals. It can then apply a SQL query that joins the “sales representative-target” table with a “leads-progress” table, which identifies the amount closed till date. The performance gauge 105 can further create a pivot view over the SQL query to display the sales representatives' current performance against the goals.

In another example, performance gauge 105 can apply a SQL query that joins the “sales representative-target” table with a “bookings-trends” table that identifies the average annual bookings made by the sales representatives during a period of time in the past or with a “opportunities-trends” table, which identifies the average number of opportunities created by sales representatives during a period of time in the past. The performance gauge 105 can then create a pivot view over the SQL query to display the sales representatives' current performance against the historical trends.

By constantly measuring sales representatives' current performance data 108 versus historical performance data 102 and current performance data 108 of relevant colleagues, performance gauge 105 can proactively identify underperforming sales representatives. Once the underperforming sales representatives are identified, coaching trigger 125 can automatically generate in real-time performance enhancement or coaching insights that are specific to each sales representative. These personalized performance enhancement or coaching insights are recorded as coaching data 122.

### Performance Tracking

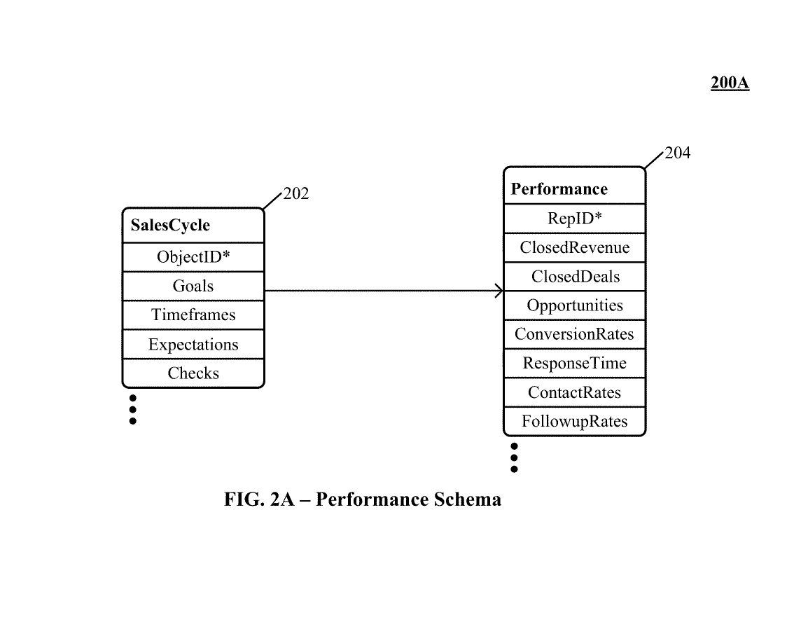

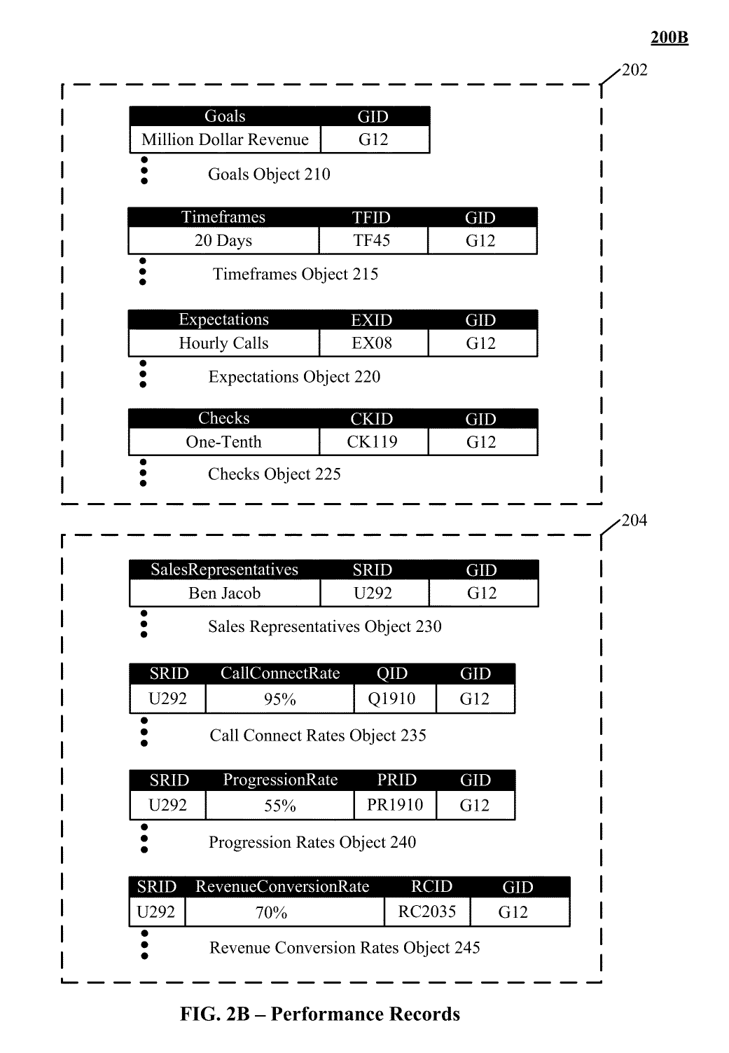

FIG. 2A is one implementation of a performance schema 200A that tracks sales initiatives juxtapose sales goals. This and other data structure descriptions that are expressed in terms of objects can also be implemented as tables that store multiple records or object types. Reference to objects is for convenience of explanation and not as a limitation on the data structure implementation. FIG. 2 shows a sales cycle object 202 linked to a performance object 204. In other implementations, performance schema 200A may not have the same objects, tables, fields or entries as those listed above and/or may have other/different objects, tables, fields or entries instead of, or in addition to, those listed above such as a quota object, revenue object, or milestones object.

Sales cycle object 202 includes fields that specify a plurality of sales goals in a sales cycle or sales process map, timeframes for achieving a first and additional sales goals, behavioral expectations for achieving the sales goals, and performance checks for measuring a sales representative's performance relative to the sales goals. For instance, a sale cycle for securing a new account can include goals such as making cold calls, filtering leads, making presentations, making proposals, entering into negotiations, and closing the deal. Furthermore, each of these goals can include one or more milestones like following-up on leads, creating a deck, identifying competitive prices, or identifying lead-specific terms, and conditions for the closing contract. While the timeframes specify the amount of time within which a goal or milestone should be completed, the behavioral expectations identify what activities or task should be and with what frequency be performed to achieve the goals or millstones.

When a performance check is executed, a sales representative's progress towards the sales goals specified in the sales cycle object 202 is determined. This is achieved by linking the sales cycle object 202 to the performance object 204, which tracks the actions taken by the sales representative in furtherance of achieving the sales goals. In particular, performance object 204 includes various performance metrics that measure the sales representative's current performance and identify quartiles associated the current performance. These quartiles are then compared to the values of the values of the fields of the sales cycle object 202.

As shown in FIG. 2B, which shows one implementation of performance records 200B that record sales initiatives against sales goals, an organization can set a goal of collecting million dollars in revenue (goals object 210). Further, the organization can update the timeframes object 215 to set 20 days as the timeframe in which the goal must be accomplished. Also, it can set a behavioral expectation for its sales representatives in expectations object 220 that requires the sales representatives to make hourly calls to identified leads or existing accounts. Finally, the checks object 225 specifies that a performance check should be executed within every one-tenth of the timeframe set for the goal, i.e. within every two days.

Sales representatives object 230 links a sales representative named ‘Ben Jacob’ to the ‘million-dollar revenue’ goal identified by the goals object 210. This tracks actions taken by Ben Jacob in furtherance of achieving the million-dollar revenue goal. Thus, when a performance check is executed every two days, Ben Jacob's calling rate (call connect rates object 235), progression rate (closing rates object 240), and revenue conversion rate (revenue conversion rates object 245) are respectively compared to the expectations object 220, timeframes object 215, and goals object 210. If the values of the performance object 204 are deficient compared to the values of the sales object 202, then, dependent on the lagging field, appropriate performance enhancement insights are automatically issued to Ben Jacob.

In other implementations, performance records 200B may not have the same objects, tables, fields or entries as those listed above and/or may have other/different objects, tables, fields or entries instead of, or in addition to, those listed above such as a pipeline-to-quota ratio object, stage progression rates object, or stage regression rates object.

### Progress Features

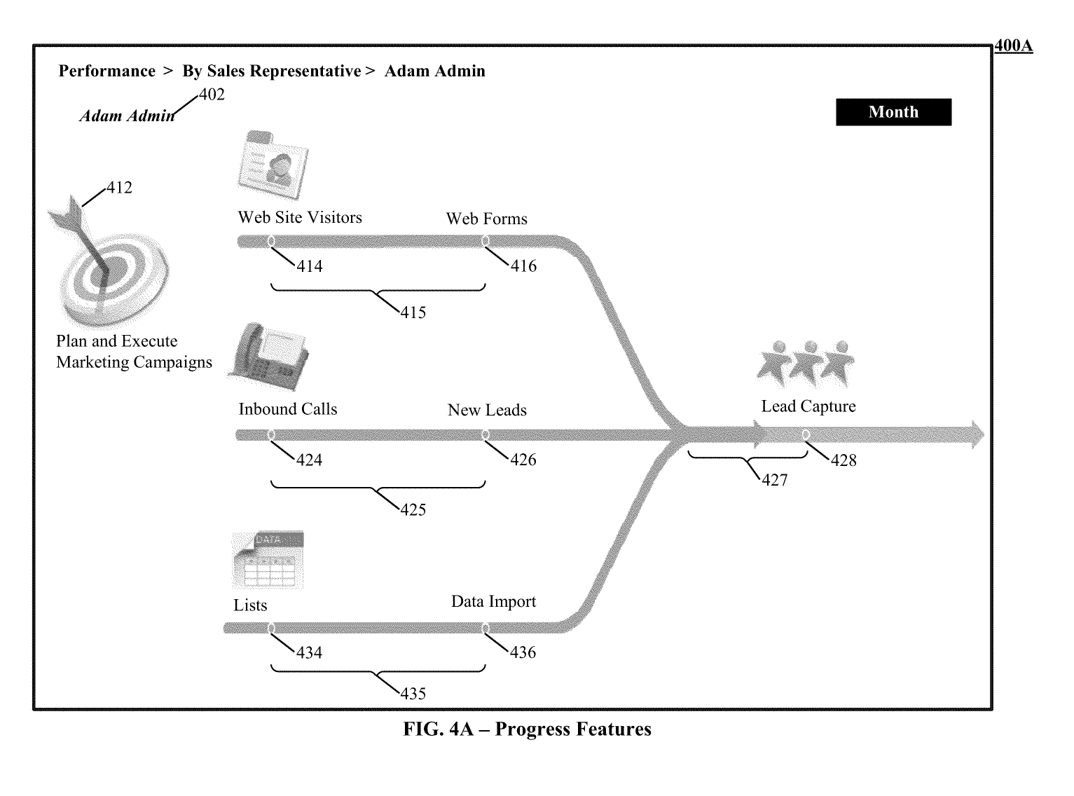

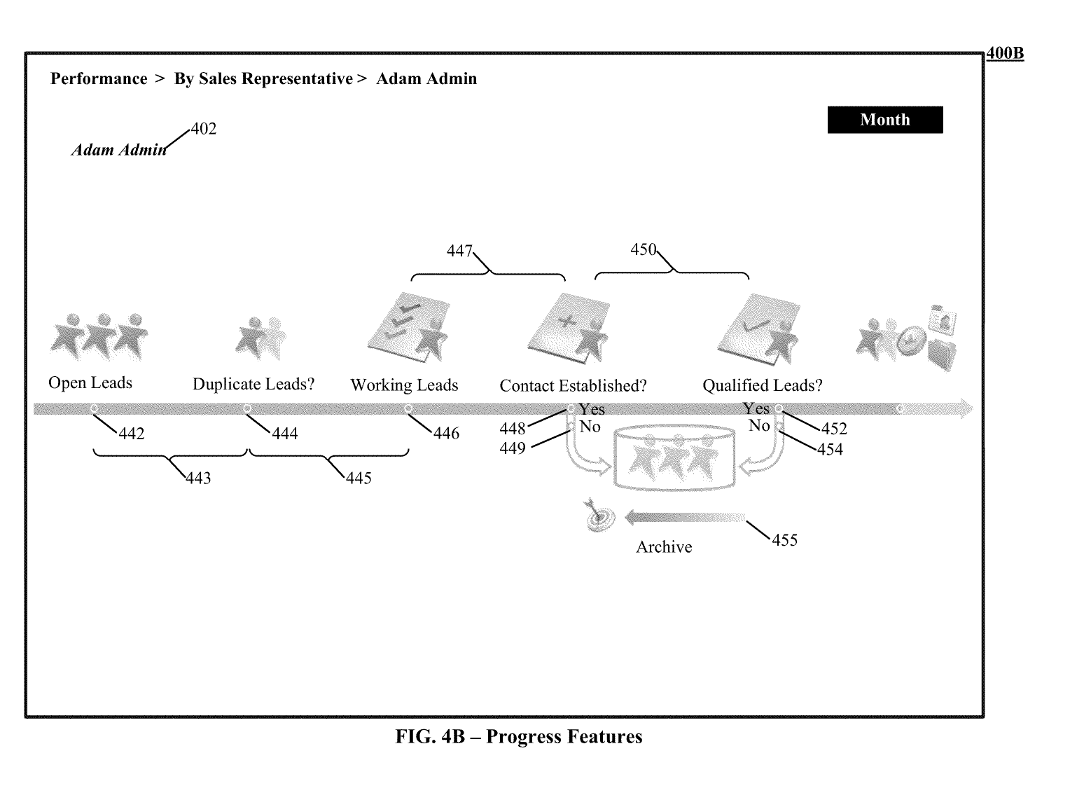

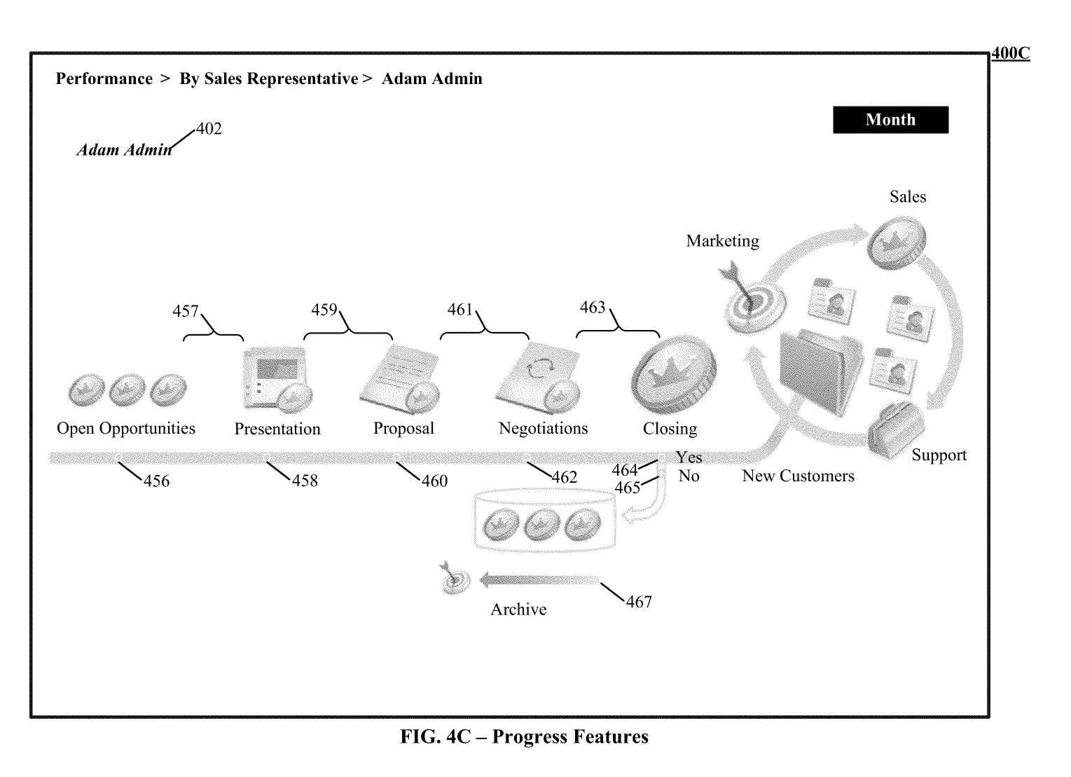

FIGS. 4A-4C illustrate one implementation of progress features extraction 400 from historical performance data 102. The progress features indicate a progression of a sales representative across a sales process map or sales cycle that represents sales flow from leads, opportunities, to accounts. FIGS. 4A-4C show various progress features, including marketing 412, lead qualification 452, presentation 458, proposal 460, negotiation 462, and closing 464. Further, FIGS. 4A-4C identify timeframes (415, 425, 435, 443, 450, 457, 459, 461, 463, etc.) within which progresses should be made from one sales performance initiative to another. For instance, when new opportunities 456 are created, a presentation 458 should be made within a timeframe 457 of 3 weeks. In other implementations, extraction 400 may not have the same features as those listed above and/or may have other/different features instead of, or in addition to, those listed above such as issue identification, ticket creation, or issue resolution. The different features can be combined into single software modules and multiple software modules can run on the same hardware.

FIGS. 4A-4C are one example of a sequence of sales performance initiatives followed by sales representatives. Performance gauge 105 extracts progress features from historical performance data 102 by automatically identifying patterns of sequence of sales performance initiatives (shown in FIGS. 4A-4C) and changes made to a sales process map in response to the sales performance initiatives. As shown in FIGS. 4A-4C, sales representatives start with planning and executing marketing campaigns 412, which includes email marketing, online ads, events, trade shows, cold calls, etc. This is followed up with capturing leads 428 by contacting web site visitors 414 using web forms 416, making inbound calls 424 to identify new leads 426, using legacy data 434, and importing contact repositories 436.

Once new leads 442 are recorded in the CRM system, the sales representatives filter out duplicate leads 444 and try to establish contact with the working leads 446. If the contact is established 448, then the working leads 446 are subjected to a qualification such as categorization based on current market situation, product of interest, etc. If the contact is not established 449, then the working leads 446 are archived. The working leads 446 that meet the qualification 452 are opened as opportunities 456 in the CRM system. Whereas, the working leads 446 that do not meet the qualification 454 are archived. Following this, sales representatives make a presentation 458, submit a proposal 460, and enter into negotiations 462. The opportunity is then either converted into an account at closing 464 or archived 467 for remarketing.

Overtime, performance gauge 105 identifies patterns of sequence of sales performance initiatives like making a presentation, which is followed by submitting a proposal, entering into negotiations, and closing. As these sales performance initiatives are entered in the CRM system, a sales funnel is simultaneously updated to reflect the progress across the sales process map or sales cycle. Performance gauge 105 then extracts the progress features by mapping the patterns of sequence of sales performance initiatives to corresponding changes in the sales funnel. Once extracted, the progress features are used as model sets for measuring a particular sales representative progress across the sales process map or sales cycle.

In other implementations, performance gauge 105 extracts progress features from historical training data by automatically identifying patterns of sequence of learning initiatives and changes made to a learning map or learning cycle in response to the learning initiatives such as orientation, training, workshops, etc. In this implementation, performance gauge 105 identifies patterns of sequence of learning initiatives like attending an orientation, which is followed by undergoing training, earning certifications, and mentoring. As these learning initiatives are entered in an education management system, a learning funnel is simultaneously updated to reflect the progress across the learning map or learning cycle. Performance gauge 105 then extracts the progress features by mapping the patterns of sequence of learning initiatives to corresponding changes in the learning funnel. Once extracted, the progress features are used as model sets for measuring a particular employee's progress across the learning map or learning cycle.

### Exception Features

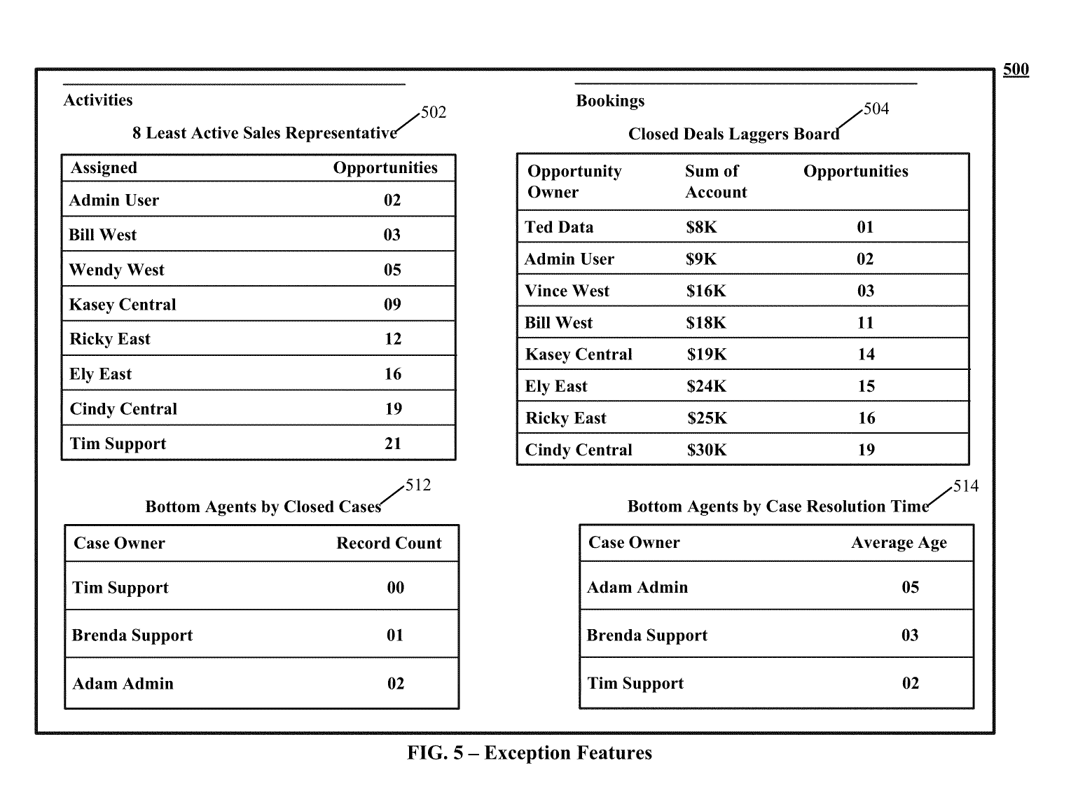

FIG. 5 shows one implementation of exception features extraction 500 from historical performance data 102. The exception features indicate low or high performance of a sales representative in a sales cycle. FIG. 5 illustrates various exception features, including least active sales representative 502, least revenue generating sales representative 504, bottom agents by closed cases 512, and bottom agents by case resolution time 514. In other implementations, extraction 500 may not have the same features as those listed above and/or may have other/different features instead of, or in addition to, those listed above such as lowest lead response time, lowest rate of contact, lowest rate of follow up contact, least clicks from sales follow-up emails, least social media usage, least usage rate of marketing collateral, or least opportunity-to-win ratio. The different features can be combined into single software modules and multiple software modules can run on the same hardware.

Performance gauge 105 extracts exception features from historical performance data 102 by applying bottom ranking functions that limit the number of value returned in the final output. In some implementations, bottom-ranking functions can be used to produce performance metrics that include in the final output only the bottom n values within certain subgroups. In one implementation, performance gauge 105 can use the following formulas to return a numerical rank for a performance metric in ascending or descending order:

SELECT RANK(Avg. Won)
SELECT RANK(Amount) ASC WITHIN(YEAR(Closed))
SELECT RANK(Amount[SUM]) WITHIN(CURRENT)
SELECT RANK(Amount[SUM]) WITHIN(ALL OTHER)

In other implementations, performance gauge 105 can identify underperforming sales representatives by applying the following bottom-ranking functions:

SELECT ... WHERE BOTTOM (...) OF ... [WITHIN ...]
SELECT metric1 WHERE [BOTTOM] (n or n%) OF ( metric2, ...)
SELECT metric1 WHERE [BOTTOM] (n or n%) OF ( metric2, ...)
WITHIN (...)

In one example, the above formulas can be used to return the 8 least active sales representatives in a sales division. In another example, the above formulas can be used to generate pivot views that display bottom 20% of sales representative relative to the number of closed deals and amount of revenue collected.

### Auto Coaching

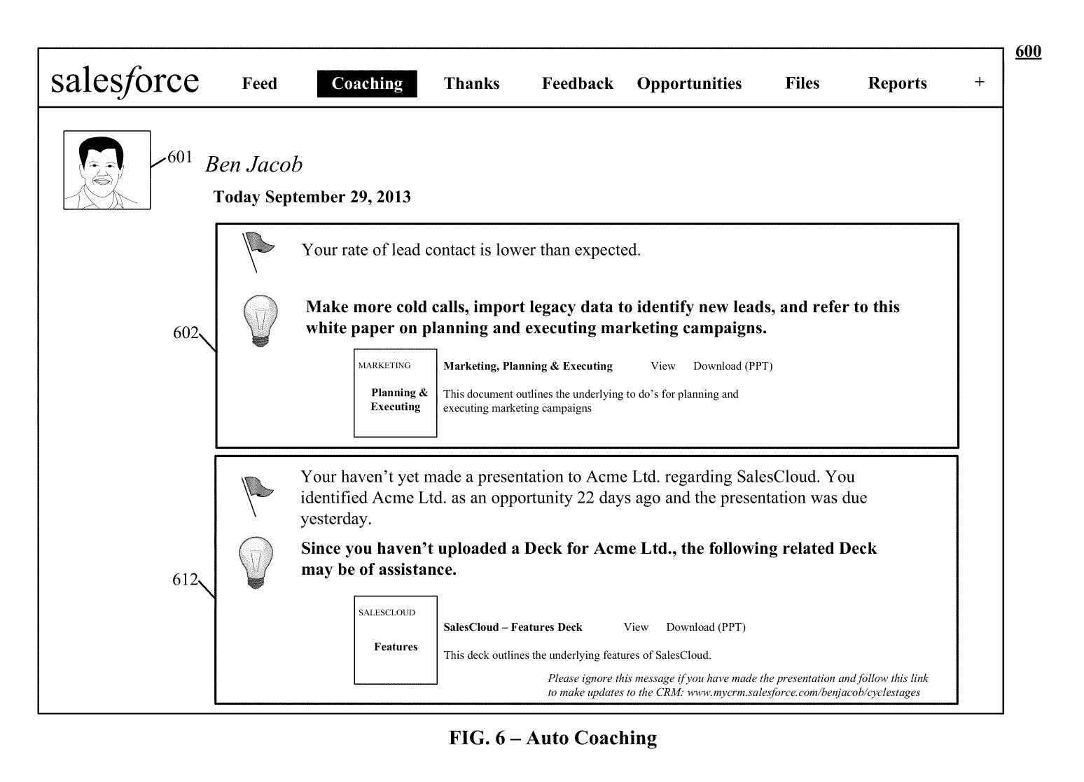

FIG. 6 illustrates one implementation of automated coaching 600 of users in an on-demand system. In particular, FIG. 6 shows a CRM profile of a sales representative 601 named ‘Ben Jacob’. Coaching trigger 125 can automatically issue personalized coaching insights 602 and 612 by evaluating the current performance of sales representative 601 against the progress features (FIGS. 4A-4C) and the exception features (FIG. 5). In one implementation, personalized coaching insights 602 and 612 are automatically issued based on the progress features (FIGS. 4A-4C) as the current performance data 108 evidences Ben Jacob's lag in progress or regression across a sales cycle or sales process map. In another implementation, personalized coaching insights 602 and 612 are automatically issued based on the exception features (FIG. 5) as the current performance data 108 evidences low or high performance of Ben Jacob.

Interface 600 can take one of a number of forms, including a user interface, dashboard interface, engagement console, and other interface, such as mobile interface, tablet interface, summary interface, or wearable interface. In some implementations, it can be hosted on a web-based or cloud-based application running on a computing device. It can also be hosted on a non-social local application running in an on-premise environment. In one implementation, it can be accessed from a browser running on a computing device. The browser can be Chrome, Internet Explorer, Firefox, Safari, and the like. In other implementations, interface 600 can run as engagement consoles on a computer desktop application.

As shown in FIG. 6, a personalized coaching insight 602 is automatically issued to sales representative 601 when the sales representative's rate of lead contact is lower than expected. Further, the personalized coaching insight 602 proposes certain context-aware solutions, which are specific to the sales representative's situation, including making more cold calls, importing legacy data, and referring to a white addressing a similar situation. In other implementations, a personalized coaching insight 602 is automatically issued to sales representative 601 when the sales representative fails to make a progress in a sales process map within a designated timeframe. This is evidenced by sales representative's failure to upload a deck in the CRM system that is required for making a presentation. Again, a certain context-aware solution is provided that is specific to the sales representative's situation and includes presenting a relevant template deck.

In some implementations, performance gauge 105 can calculate various performance metrics measuring the sales representative's performance, including closing dates push/pull, lead response time, rate of follow, call connect to opportunity rate, opportunity-to-win ratio, rate of contact, average opportunity age, pipeline by product family, activity, winning competitor, etc. If the values calculated by the performance metrics are deficient to that of set sales goals, or to the model values of the progress features and exception features, then the coaching trigger 125 can issue appropriate coaching insights. The coaching insights are customized based on the performance metrics in which the deficiencies are identified.

For instance, if the model alteration limits on closing dates for deals is five and sales representative 601 pushes out the closing date for an opportunity ten times, then this can be an indicator of poor forecasting and as a result coaching trigger 125 can automatically issue a coaching note specifically addressing this problem. Similarly, if sales representative 601 has a low lead response time, then this can be an indicator of quality problems in the early stages of the sales cycle. The coaching trigger 125 can then automatically issue a coaching note that includes inspection results of sales representative's sales funnel and identification of any follow-on effects. Also, if sales representative 601 has a slow rate of lead follow-ups, then coaching trigger 125 can automatically create a schedule for call down on follow-up leads. In another example, if sales representative 601 has a poor opportunity-to-win ratio, then coaching trigger 125 can automatically schedule ride-alongs with the appropriate manger or expert for later stages of sales calls or meetings.

In other implementations, coaching trigger 125 can automatically issue personalized coaching insights using Apex triggers. Triggers can act as scripts that execute before or after specific data manipulation language (DML) events occur, such as before object records are inserted into the database, timestamps values are recorded, or after records have been deleted. For instance, when a sales representative fails to closes an opportunity and archives it, coaching trigger 125 can use the following Apex code to issue a personalized coaching insight:

```
Trigger giveInsight on Opportunity (after update) {
  for (Opportunity opp : Trigger.new){
  if ( (opp.stagename == ‘Archived Lost’ ) &&
  (trigger.oldMap.get(opp.id).stagename != ‘Archived Lost’) ) {
    WorkConnector.SendInsightAndPrivatelyPostToChatter-
    (trigger.new[0].id, false);
  }}}
```

In the Apex code above, when the opportunity's stage name is updated in a CRM system to be archived or lost (Opportunity Stagename==‘Archived Lost’), the Apex trigger (giveInsight) can call an Apex class called ‘WorkConnector’ according to one implementation, which can privately post the issued personalized coaching insight in one or more social profiles of the underperforming sales representative 601, including Chatter, Facebook, Twitter, etc. In other implementations, depending on the type of lagging indicator, the Apex trigger can issue different personalized coaching insights, as shown in the Apex code below:

```
if (response.time <= 2) & (call.connect <= 20) {
  insightType = level_one_timing_solution( );
} else if (response.time <= 2) & (call.connect <= 10){
  insightType = level_one_timing_solution( );
} else {
  return;}
```

In other implementations, automated coaching 600 may not have the same screen objects, interfaces, or widgets as those listed above and/or may have other/different screen objects, interfaces, or widgets instead of, or in addition to, those listed above. The different elements can be combined into single software modules and multiple software modules can run on the same hardware. Other examples of personalized coaching insights or context-aware solutions can include, depending on the lagging indicator, identifying new contact mediums, automatically scheduling meetings with managers or experts, identifying centers of influence or thought leaders, proposing organizing techniques, etc.

### User Triggered Coaching

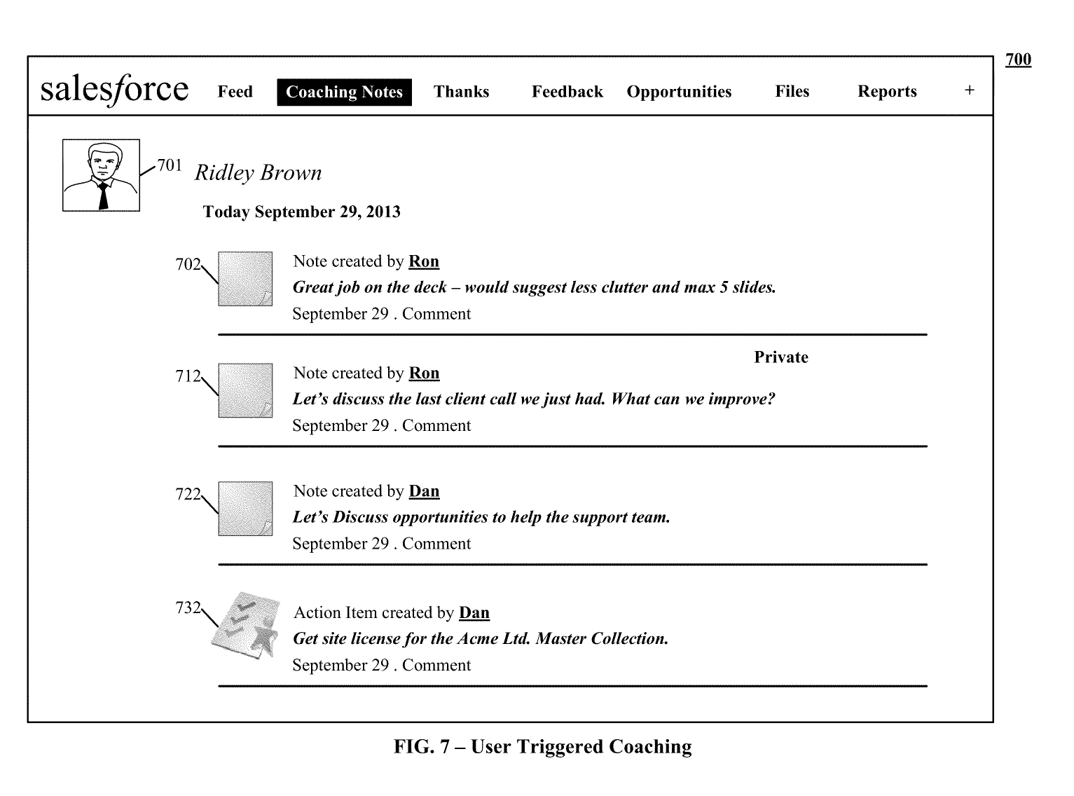

FIG. 7 is one implementation of user triggered coaching 700 of users in an on-demand system. FIG. 7 shows an interface 700 on which managers named ‘Ron’ and ‘Dan’ created one-to-one coaching notes for a sales representative 701, named ‘Ridley Brown’. In other implementations, coaching 700 may not have the same screen objects, interfaces, or widgets as those listed above and/or may have other/different screen objects, interfaces, or widgets instead of, or in addition to, those listed above such as audio notes, videos, URL, simulations, etc. The different elements can be combined into single software modules and multiple software modules can run on the same hardware.

As shown in FIG. 7, one-to-one coaching notes (703, 712, and 722) are issued to sales representative 701 by managers Ron and Dan. In some implementations, an action item 732 is assigned to sales representative 701, which requires some action on the sales representatives' behalf. In one implementation, a one-to-one coaching note or action item can be made private so that its view is restricted to sales representative 701.

Interface 700 can take one of a number of forms, including a user interface, dashboard interface, engagement console, and other interface, such as mobile interface, tablet interface, summary interface, or wearable interface. In some implementations, it can be hosted on a web-based or cloud-based application running on a computing device. It can also be hosted on a non-social local application running in an on-premise environment. In one implementation, it can be accessed from a browser running on a computing device. The browser can be Chrome, Internet Explorer, Firefox, Safari, and the like. In other implementations, interface 700 can run as engagement consoles on a computer desktop application.

### Coaching Schema

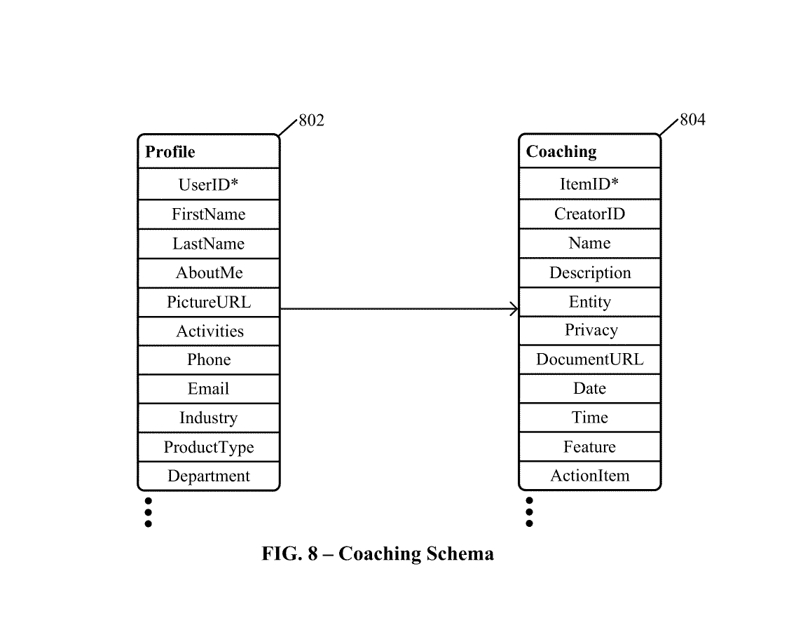

FIG. 8 shows one implementation of a coaching schema 800 that can be used for coaching users in an on-demand system. This and other data structure descriptions that are expressed in terms of objects can also be implemented as tables that store multiple records or object types. Reference to objects is for convenience of explanation and not as a limitation on the data structure implementation. FIG. 8 shows a profile object 802 linked to a coaching object 804. In other implementations, coaching schema 800 may not have the same objects, tables, fields or entries as those listed above and/or may have other/different objects, tables, fields or entries instead of, or in addition to, those listed above such as a statistics object, rules object, or skills object.

As shown in FIG. 8, coaching schema 800 is updated to record assignments of personalized coaching insights or notes to a sales representative. Coaching schema 800 can allow managers to see which coaching plans work best at overcoming specific skill deficiencies, and who has most recently overcome them. Knowing that a plan has worked in the past can give both manager and sales representative confidence that their hard work may pay off and a sales representative who has recently overcome a common deficiency can be of great help to those currently struggling with the same issue.

In one implementation, profile object 802 provides primary information that identifies a sales representative and includes various fields that store biographic information about the sales representative such as first name, last name, sex, birthday, department, interests, etc. In some implementations, the profile object 802 can be further linked to other objects that provide supplementary information about the sales representative.

In some implementations, profile object 802 is linked to a coaching object 804, which identifies the coaching insights or notes issued to the sales representative. Coaching object 804 includes a field referred to as ‘ItemID*’ that uniquely identifies a coaching insight or note. It also includes other fields such as: ‘CreatorID’ that identifies the creator of the coaching insight or note as either the system (auto coaching) or a user (user triggered coaching), ‘Name’ that identifies the name of the coaching insight or note, ‘Description’ that provides a summary of the coaching insight or note, ‘Entity’ that identifies a lead, opportunity, or account to which the coaching insight or note pertains, ‘Privacy’ that specifies who can view the coaching insight or note, ‘DocumentURL’ that holds any documents or other audio, video, text content included in the coaching insight or note, ‘Date’ that specifies the date on which the coaching insight or note was issued, ‘Time’ that specifies the time on which the coaching insight or note was issued, ‘Feature’ that specifies the lagging indicator (progress feature, exception feature) to which the coaching insight or note pertains, and ‘ActionItem’ that identifies any action items associated with the coaching insight or note.

In yet another implementation, schema 800 can have one or more of the following variables with certain attributes: USER_ID being CHAR (15 BYTE), ENTITY_ID being CHAR (15 BYTE), CONTENT_LINK_ID being CHAR (15 BYTE), SUMMARY_ID being CHAR (15 BYTE), PRIVILEGES_TYPE_ID being CHAR (15 BYTE), FEATURE_ID being CHAR (15 BYTE), CREATED_BY being CHAR (15 BYTE), CREATED_DATE being DATE, and DELETED being CHAR (1 BYTE).

### Flowchart of Proactively Coaching Users

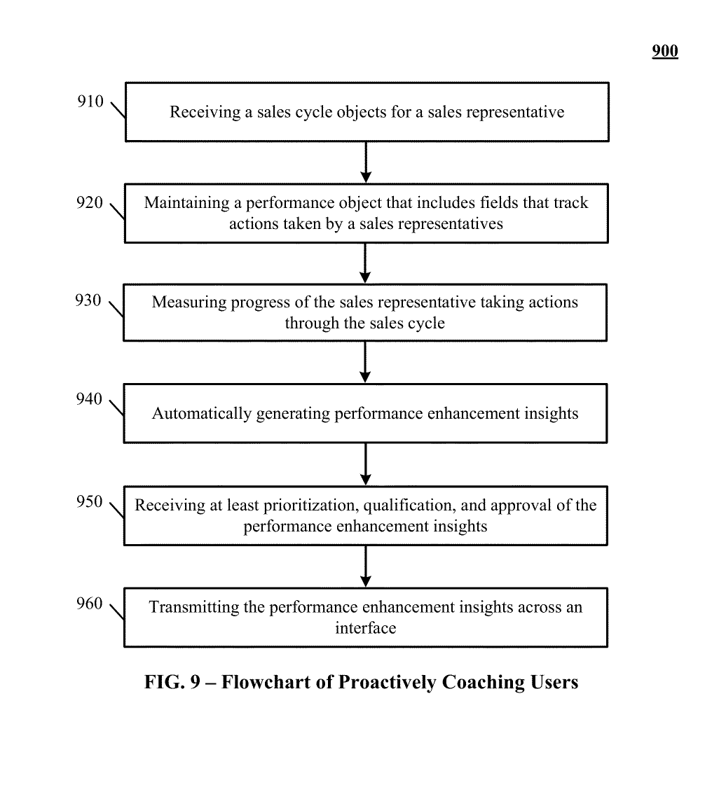

FIG. 9 is a flowchart 900 of one implementation of proactively coaching users in an on-demand system. Flowchart 900 can be implemented at least partially with a database system, e.g., by one or more processors configured to receive or retrieve information, process the information, store results, and transmit the results. Other implementations may perform the actions in different orders and/or with different, fewer or additional actions than the ones illustrated in FIG. 9. Multiple actions can be combined in some implementations. For convenience, this flowchart is described with reference to the system that carries out a method. The system is not necessarily part of the method.

At action 910, a sales cycle object for a sales representative is received. The sales cycle objet includes fields that specify a plurality of sales goals in a sales cycle, timeframes for achieving a first and additional sales goals, and behavioral expectations for achieving the sales goals. The sales goals specify model rates of converting leads into prospects. The model rates of converting leads into prospects are stratified dependent on the solicitation medium such as calls, e-mails, social posts, in-person meetings, etc. The sales goals also specify model rates of converting prospects into accounts. The model rates of converting prospects are stratified into accounts dependent on solicitation medium such as calls, e-mails, social posts, in-person meetings, etc. The sales goals further specify model rates of revenue conversion on closed deals. The behavioral expectations specify model lead or account response times, model alteration limits on closing dates for deals, model rates of prospect or lead contact, and model rates of lead follow-ups.

At action 920, a performance object is maintained that includes fields that track actions taken by the sales representative in furtherance of achieving the sales goals. In particular, the performance object includes various performance metrics that measure the sales representative's current performance and identify quartiles associated the current performance. These quartiles are then compared to the values of the values of the fields of the sales cycle object.

At action 930, progress of the sales representative taking actions through the sales cycle is measured by periodically executing performance checks. A first performance check is executed within a designated portion of a timeframe for achieving a first sales goal in the sales cycle. The designated portion of the timeframe is usually a fraction of the timeframe, which allows consistent and proactive identification of lags or regressions, early in the sales cycle.

At action 940, in response to the execution of the performance checks, personalized performance enhancement insights are automatically generated by comparing values of the fields of the performance object to values of the fields of the sales cycle object. The personalized performance enhancement insights are specific to the sales representative and assist the sales representative in achieving the sales goals. In some implementations, the personalized performance enhancement insights are automatically generated by comparing the values of the fields of the performance object to at least one of historical sales performance data and/or sales performance data of high performing relevant colleagues.

In one implementation, the personalized performance enhancement insights are dependent on feedback provided by a supervisor of the sales representative. In another implementation, a calendar event is automatically registered that schedules a meeting between the sales representative and a supervisor of the sales representative responsive.

At action 950, at least prioritization, qualification, and approval of the personalized performance enhancement insights are received, which includes receiving preferences that specify at least points in the sales cycle at which performance checks are to be executed and portions of the timeframes within which performance checks are to be executed.

At action 960, the personalized performance enhancement insights are transmitted across an interface for use by the sales representative. In one implementation, the personalized performance enhancement insights are automatically incorporated and highlighted in performance summaries of the sales representative. In some implementations, the personalized performance enhancement insights can be posted as binary content type in the CRM system providing the performance summaries. In another implementation, the personalized performance enhancement insights are automatically embedded and highlighted in social media profiles (Chatter, Facebook, Twitter, etc.) of the sales representative. In some implementations, the personalized performance enhancement insights can be posted as binary content type in the feeds of the social media profiles.

### Flowchart of Automatically Issuing Personalized Coaching Insights

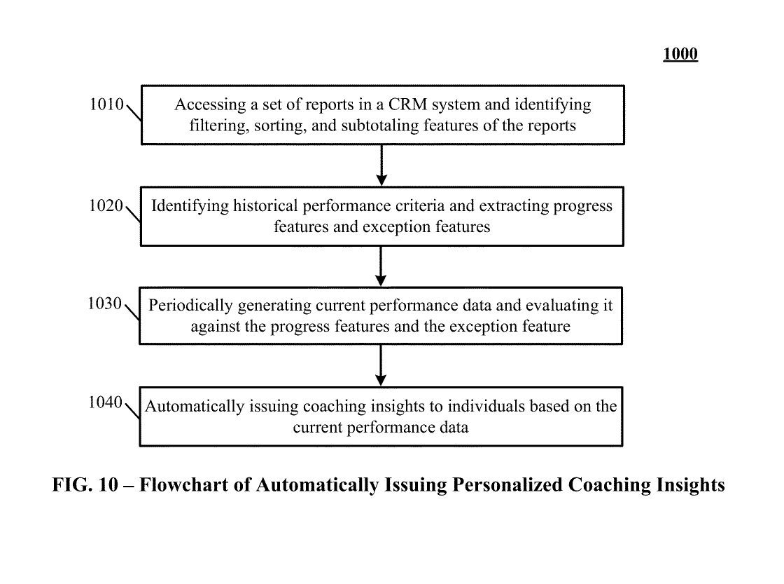

FIG. 10 illustrates a flowchart 1000 of one implementation of automatically issuing personalized coaching insights to users in an on-demand system. Flowchart 1000 can be implemented at least partially with a database system, e.g., by one or more processors configured to receive or retrieve information, process the information, store results, and transmit the results. Other implementations may perform the actions in different orders and/or with different, fewer or additional actions than the ones illustrated in FIG. 10. Multiple actions can be combined in some implementations. For convenience, this flowchart is described with reference to the system that carries out a method. The system is not necessarily part of the method.

At action 1010, a set of reports in a CRM system is accessed and filtering, sorting, and subtotaling features of the reports are identified. A CRM system allows organizations to manage business relationships and the data and information associated with them. It allows organizations to store customer and contact information as reports. A report returns a set of records that meets certain criteria, and displays it in organized rows and columns. Report data can be filtered, grouped, sorted, and displayed graphically as a chart. A report type defines the set of records and fields available to a report based on the relationships between a primary object and its related objects.

At action 1020, historical performance criteria is identified using the filtering, sorting, and subtotaling features of the reports and historical performance data is analyzed to extract progress features and exception features of the historical performance data. The progress features indicate a progression of an individual, and the exception features indicate low or high performance of an individual. Analyzing the historical performance data to extract progress features includes automatically identifying at least patterns of sequence of sales performance initiatives and changes to a sales process map in response to the sales performance initiatives. Also, analyzing the historical performance data to extract exception features includes automatically identifying low or high performances by applying bottom or top ranking functions.

At action 1030, current performance data is periodically generated and evaluated against the progress features and the exception feature. In particular, sales representatives' current performance can be analyzed against: goals set at the beginning of a quarter, sales activities by region and quarter, revenue distribution by sales region, revenue and closure trend by sales industry, quota performance by sales district, etc. to identify high performing sales representatives.

At action 1040, coaching insights are automatically issued to individuals based on the current performance data. The coaching insights are automatically issued based on the progress features as the current performance data evidences lag in progress or regression across a sales process map. The coaching insights are also automatically issued based on the exception features as the current performance data evidences low or high performance.

### Computer System

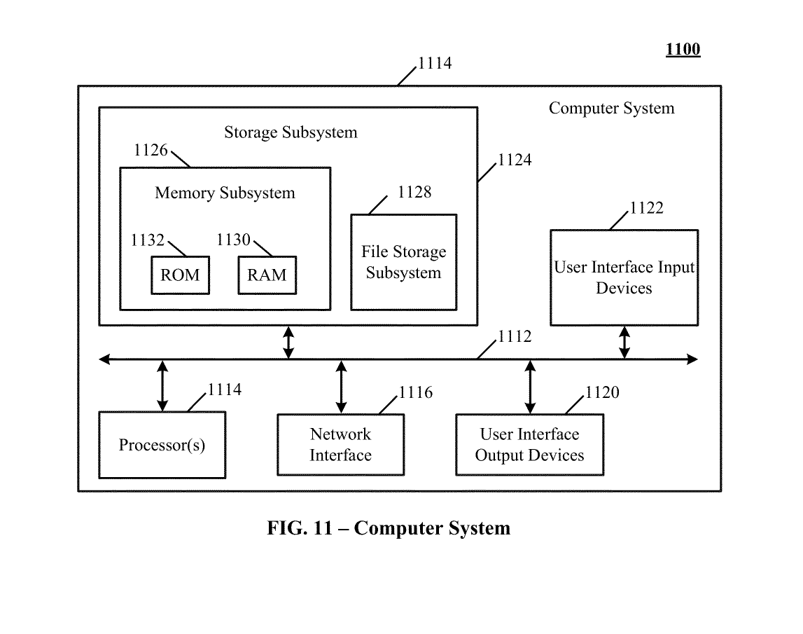

FIG. 11 is a block diagram of an example computer system 1100 used for coaching users in an on-demand system. FIG. 11 is a block diagram of an example computer system, according to one implementation. Computer system 1110 typically includes at least one processor 1114 that communicates with a number of peripheral devices via bus subsystem 1112. These peripheral devices can include a storage subsystem 1124 including, for example, memory devices and a file storage subsystem, user interface input devices 1122, user interface output devices 1120, and a network interface subsystem 1116. The input and output devices allow user interaction with computer system 1110. Network interface subsystem 1116 provides an interface to outside networks, including an interface to corresponding interface devices in other computer systems.

User interface input devices 1122 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1110.

User interface output devices 1120 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1110 to the user or to another machine or computer system.

Storage subsystem 1124 stores programming and data constructs that provide the functionality of some or all of the modules and methods described herein. These software modules are generally executed by processor 1114 alone or in combination with other processors.

Memory 1126 used in the storage subsystem can include a number of memories including a main random access memory (RAM) 1130 for storage of instructions and data during program execution and a read only memory (ROM) 1132 in which fixed instructions are stored. A file storage subsystem 1128 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1128 in the storage subsystem 1124, or in other machines accessible by the processor.

Bus subsystem 1112 provides a mechanism for letting the various components and subsystems of computer system 1110 communicate with each other as intended. Although bus subsystem 1112 is shown schematically as a single bus, alternative implementations of the bus subsystem can use multiple busses.

Computer system 1110 can be of varying types including a workstation, server, computing cluster, blade server, server farm, or any other data processing system or computing device. Due to the ever-changing nature of computers and networks, the description of computer system 1110 depicted in FIG. 11 is intended only as one example. Many other configurations of computer system 1110 are possible having more or fewer components than the computer system depicted in FIG. 11.

### Particular Implementations

In one implementation, a method is described from the perspective of a server receiving messages from user software. The method includes receiving a sales cycle data object for a sales representative that includes fields that specify a plurality of sales goals in a sales cycle, timeframes for achieving a first and additional sales goals, and behavioral expectations for achieving the sales goals. It includes maintaining a performance data object that includes fields that track actions taken by a sales representative in furtherance of achieving the sales goals and measuring progress of the sales representative taking actions through the sales cycle by periodically executing performance checks. A first performance check is executed within a designated portion of a timeframe for achieving a first sales goal in the sales cycle. It also includes, in response to the performance checks, automatically generating personalized performance enhancement insights by comparing values of the fields of the performance object to values of the fields of the sales cycle object. The personalized performance enhancement insights are specific to the sales representative and assist the sales representative in achieving the sales goals. It further includes transmitting the personalized performance enhancement insights across an interface for use by the sales representative.

This and other method described can be presented from the perspective of a mobile device and user software interacting with a server. From the mobile device perspective, the method includes receiving a sales cycle data object for a sales representative that includes fields that specify a plurality of sales goals in a sales cycle, timeframes for achieving a first and additional sales goals, and behavioral expectations for achieving the sales goals. The method relies on the server to maintain a performance data object that includes fields that track actions taken by a sales representative in furtherance of achieving the sales goals and measuring progress of the sales representative taking actions through the sales cycle by periodically executing performance checks. A first performance check is executed within a designated portion of a timeframe for achieving a first sales goal in the sales cycle. It also includes, in response to the performance checks, automatically generating personalized performance enhancement insights by comparing values of the fields of the performance object to values of the fields of the sales cycle object. The personalized performance enhancement insights assist the sales representative in achieving the sales goals. It further includes transmitting the personalized performance enhancement insights across an interface of the mobile device for use by the sales representative.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as coaching environment, progress features, exception features, auto coaching, or user triggered coaching.

The method also includes automatically generating personalized performance enhancement insights by comparing the values of the fields of the performance object to at least one of historical sales performance data and high sales performance data.

The sales goals specify model rates of converting leads into prospects and the method includes stratifying the model rates of converting leads into prospects dependent on solicitation medium. The sales goals also specify model rates of converting prospects into accounts and the method also includes stratifying the model rates of converting prospects into accounts dependent on solicitation medium. The sales goals further specify model rates of revenue conversion on closed deals.

The behavioral expectations specify model lead or account response times, model alteration limits on closing dates for deals, model rates of prospect or lead contact, and model rates of lead follow-ups.

The method also includes receiving at least prioritization, qualification, and approval of the personalized performance enhancement insights before transmitting the personalized performance enhancement insights across the interface for use by the sales representative. The method further includes receiving preferences that specify at least points in the sales cycle at which performance checks are to be executed and portions of the timeframes within which performance checks are to be executed.

The method also includes generating personalized performance enhancement insights dependent on feedback provided by a supervisor of the sales representative responsive to the performance checks. The method further includes automatically registering a calendar event that schedules a meeting between the sales representative and a supervisor of the sales representative responsive to the performance checks.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In another implementation, a method is described from the perspective of a server receiving messages from user software. The method includes receiving a sales goal object that includes fields that specify a plurality of sales milestones that contribute to accomplishment of a sales goal, timeframes for achieving the sales milestones, and behavioral expectations for achieving the sales milestones. It includes maintaining a performance object that includes fields that track actions taken by a sales representative in furtherance of achieving the sales milestones and measuring progress of the sales representative towards the sales goal by periodically executing performance checks. A first performance check is executed within a designated portion of a timeframe for achieving a first sales milestone that contributes to accomplishment of the sales goal. It also includes, in response to the performance checks, automatically generating personalized performance enhancement insights by comparing values of the fields of the performance object to values of the fields of the sales goal object. The personalized performance enhancement insights assist the sales representative in achieving the sales milestones. It further includes transmitting the personalized performance enhancement insights across an interface for use by the sales representative.

This method and other implementations of the technology disclosed can include one or more of the following features and/or features described in connection with additional methods disclosed.

The method also includes automatically generating personalized performance enhancement insights by comparing the values of the fields of the performance object to at least one of historical sales performance data and high sales performance data.

The sales goals specify model rates of converting leads into prospects and the method includes stratifying the model rates of converting leads into prospects dependent on solicitation medium. The sales goals also specify model rates of converting prospects into accounts and the method also includes stratifying the model rates of converting prospects into accounts dependent on solicitation medium. The sales goals further specify model rates of revenue conversion on closed deals.

The behavioral expectations specify model lead or account response times, model alteration limits on closing dates for deals, model rates of prospect or lead contact, and model rates of lead follow-ups.

The method also includes receiving at least prioritization, qualification, and approval of the personalized performance enhancement insights before transmitting the personalized performance enhancement insights across the interface for use by the sales representative. The method further includes receiving preferences that specify at least points in the sales cycle at which performance checks are to be executed and portions of the timeframes within which performance checks are to be executed.

The method also includes generating personalized performance enhancement insights dependent on feedback provided by a supervisor of the sales representative responsive to the performance checks. The method further includes automatically registering a calendar event that schedules a meeting between the sales representative and a supervisor of the sales representative responsive to the performance checks.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In yet another implementation, a method is described from the perspective of a server receiving messages from user software. The method includes accessing a set of reports in a CRM system and identifying filtering, sorting, and subtotaling features of the reports. It includes identifying historical performance criteria using the filtering, sorting, and subtotaling features of the reports and analyzing historical performance data for the identified criteria to extract progress features and exception features. The progress features indicate a progression of an individual and the exception features indicate low performance of an individual. It further includes periodically generating current performance data and evaluating the current performance data against the progress features and the exception feature and automatically issuing personalized coaching insights to individuals based on the current performance data. The personalized coaching insights are automatically issued based on the progress features as the current performance data evidences lag in progress or regression across a sales process map. The personalized coaching insights are also automatically issued based on the exception features as the current performance data evidences low performance.

This method and other implementations of the technology disclosed can include one or more of the following features and/or features described in connection with additional methods disclosed.

Analyzing the historical performance data to extract progress features includes automatically identifying at least one of patterns of sequence of sales performance initiatives and changes to a sales process map in response to the sales performance initiatives. Analyzing the historical performance data to extract exception features includes automatically identifying low performances by applying bottom ranking functions.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

1. A method, including:
receiving by a processor a sales cycle object for a sales representative that includes fields that specify a plurality of sales goals in a sales cycle, timeframes for achieving a first and additional sales goals, and behavioral expectations for achieving the sales goals;
maintaining a performance object that includes fields that track actions taken by the sales representative in furtherance of achieving the sales goals;
measuring progress of the sales representative taking actions through the sales cycle by periodically executing performance checks, wherein a first performance check is executed within a designated portion of a timeframe for achieving a first sales goal in the sales cycle;
in response to the performance checks, automatically generating personalized performance enhancement insights by comparing values of the fields of the performance object to values of the fields of the sales cycle object, wherein the personalized performance enhancement insights are specific to the sales representative and assist the sales representative in achieving the sales goals; and
transmitting the personalized performance enhancement insights across an interface for use by the sales representative.

2. The method of claim 1, further including automatically generating personalized performance enhancement insights by comparing the values of the fields of the performance object to at least one of historical sales performance data and high sales performance data.

3. The method of claim 1, wherein the sales goals specify model rates of converting leads into prospects.

4. The method of claim 3, further including stratifying the model rates of converting leads into prospects dependent on solicitation medium.

5. The method of claim 1, wherein the sales goals specify model rates of converting prospects into accounts.

6. The method of claim 5, further including stratifying the model rates of converting prospects into accounts dependent on solicitation medium.

7. The method of claim 1, wherein the sales goals specify model rates of revenue conversion on closed deals.

8. The method of claim 1, wherein the behavioral expectations specify model lead or account response times.

9. The method of claim 1, wherein the behavioral expectations specify model alteration limits on closing dates for deals.

10. The method of claim 1, wherein the behavioral expectations specify model rates of prospect or lead contact.

11. The method of claim 1, wherein the behavioral expectations specify model rates of lead follow-ups.

12. The method of claim 1, further including receiving at least prioritization, qualification, and approval of the personalized performance enhancement insights before transmitting the personalized performance enhancement insights across the interface for use by the sales representative.

13. The method of claim 1, further including receiving preferences that specify at least:
points in the sales cycle at which performance checks are to be executed; and
portions of the timeframes within which performance checks are to be executed.

14. The method of claim 1, further including generating personalized performance enhancement insights dependent on feedback provided by a supervisor of the sales representative responsive to the performance checks.

15. The method of claim 1, further including automatically registering a calendar event that schedules a meeting between the sales representative and a supervisor of the sales representative responsive to the performance checks.

16. A method, including:
accessing by a processor a set of reports in a CRM system to identify historical performance data;
analyzing the historical performance data for one or more historical performance criteria to extract progress features and exception features;
periodically generating current performance data; and
evaluating the current performance data against the progress features and the exception features and automatically issuing recognition awards to individuals based on the current performance data, wherein
personalized coaching insights are automatically issued based on the progress features as the current performance data evidences lag in progress or regression across a sales process map; and
personalized coaching insights are automatically issued based on the exception features as the current performance data evidences low or high performance.

17. The method of claim 16, wherein the historical performance data are identified using filtering, sorting, and subtotaling features of the reports.

18. The method of claim 16, wherein analyzing the historical performance data to extract progress features includes automatically identifying at least one of:
patterns of sequence of sales performance initiatives; and
changes to a sales process map in response to the sales performance initiatives.

19. The method of claim 16, wherein analyzing the historical performance data to extract exception features includes automatically identifying low or high performances by applying bottom or top ranking functions.

20. A system, including:
a processor and a computer readable storage medium storing computer instructions configured to cause the processor to:
access a set of reports in a CRM system to identify historical performance data;
analyze the historical performance data for one or more historical performance criteria to extract progress features and exception features;
periodically generate current performance data; and
evaluate the current performance data against the progress features and the exception features and automatically issue recognition awards to individuals based on the current performance data, wherein
personalized coaching insights are automatically issued based on the progress features as the current performance data evidences lag in progress or regression across a sales process map; and
personalized coaching insights are automatically issued based on the exception features as the current performance data evidences low or high performance.
